(19) United States
(12) Patent Application Publication
(10) Pub. No.: US 2005/0174078 A1
(43) Pub. Date: Aug. 11, 2005

(54) Electrical phase reversing switch

(76) Inventors: Gheorghe Betiu, Kingwood, TX (US); Randy Porter, Kingwood, TX (US)

Correspondence Address: GHEORGHE BETIU, 4314 LONG GLEN DRIVE, KINGWOOD, TX, 77339, US

(21) Appl. No.: 11/034,666

(22) Filed: Jan. 13, 2005

Related U.S. Application Data
(60) Provisional application No. 60/542,601, filed on Feb. 7, 2004.

(51) Int. Cl. H02P 1/00

(52) U.S. Cl. 318/280

(57) ABSTRACT

This device is connected to the bottom of a conventional motor starter. When is necessary it can be switched to allow the phases to be reversed. In this application the rotation is changed to the opposite direction. The benefit of this process is help in clearing jams or changing rotation of pumps and other. This apparatus will be helpful in the manufacturing industry and other.

### BACKGROUND OF THE INVENTION

### FIELD OF THE INVENTION

This invention relates generally to the field of apparatus for an Electrical Phase Reversing Switch. Moreover it pertains specifically to such apparatus for Reversing electrical motor directions

### BRIEF SUMMARY OF THE INVENTION

In view of the limitations now present in the prior art, the present invention provides a new and useful Electrical Phase Reversing Switch which is simpler in construction, more universally usable and more versatile in operation than known apparatus of this kind.

The purpose of the present invention is to provide a new Electrical Phase Reversing Switch device that has many novel features not offered by the prior art apparatus that result in a new Electrical Phase Reversing Switch device which is not apparent, obvious, or suggested, either directly or indirectly by any of the prior art apparatus

Electrical Phase Reversing Switch

The present invention is a box comprised of contacts that can be manually switched to allow the electrical three-phase motor to be reversed. The device is connected to the bottom of a conventional motor starter. When necessary, a contact bar is pushed (or a cylinder is turned) in one direction or the other to allow phases to be reversed. By doing this, it makes it possible for an apparatus to be reversed in its rotation for temporary maintenance. The device has a bar or a cylinder with six input contacts named I1, I2, I3, I4, I5 and I6 and another six output contacts named O1, O2, O3, O4, O5, O. When contacts I1, O1; I3, O3 and I5, O5 are in use, it is normal rotation and when contacts I2, O2; I4, O6 andI6, O4 are in use, the rotation is in opposite direction. The initial power leads (L1, L2, and L3) are tied into the top of the apparatus. The connections T1, T2, and T3 are tied to the bottom of apparatus. Initial the power leads are connected to I1, I3 and I5 and when are switching these contacts move to I2, I4, and I.

The foregoing has outlined, in general, the physical aspects of the invention and is to serve as an aid to better understanding the more complete detailed description, which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1. is a perspective view of an Electrical Phase Reversing Switch according to the present invention.

FIG. 2. is a front view of an Electrical Phase Reversing Switch according to the present invention.

FIG. 3. is a top view of an Electrical Phase Reversing Switch according to the present invention.

FIG. 4. is a side view of an Electrical Phase Reversing Switch according to the present invention.

FIG. 5. is a cross sectional view of the present invention seen in FIG. 3, taken along lines A-A of that drawing.

FIG. 6. is a cross sectional view of the present invention seen in FIG. 3, taken along line B-B of that drawing.

FIG. 7. is a cross sectional view of the present invention seen in FIG. 3, taken along line C-C of that drawing.

FIG. 8. is an electrical schematic draw of the Electrical Phase Reversing Switch for the first position on linear motion.

FIG. 9. is an electrical schematic draw of the Electrical Phase Reversing Switch for the second position on linear motion.

FIG. 10. is an electrical schematic draw of the Electrical Phase Reversing Switch for the first position on rotating motion.

FIG. 11. is an electrical schematic draw of the Electrical Phase Reversing Switch for the second position on rotating motion.

### DETAILED DESCRIPTION OF THE INVENTION

Referring now descriptively to the drawings, the attached figures illustrate an Electrical Phase Reversing Switch

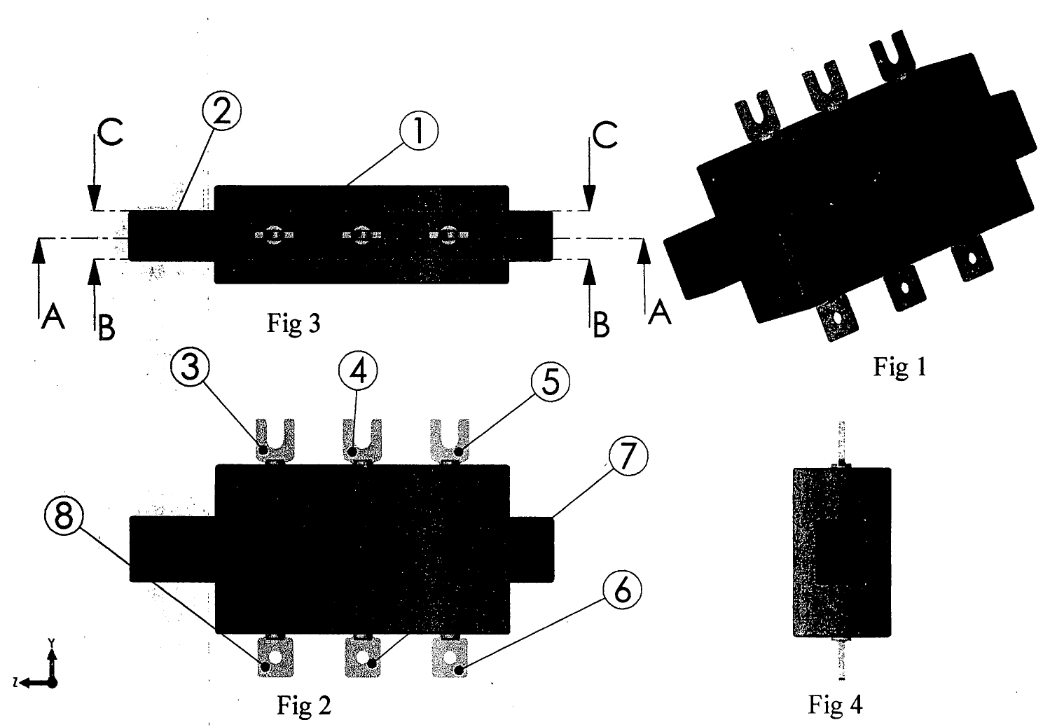

FIGS. 1 illustrates an Electrical Phase Reversing Switch according to the present invention, this device is reversing the electrical motor directions.

The present invention is a complete new device used in electrical field as an electrical motor change direction. The principle is using for Three phase Electrical Motor and consist in switching two phases of initial power to reverse the direction. We know that conventional three phase power is notate with symbols L1, L2, L3, and are call initial power leads. Electrical Three Phase Motor has three input connections which are symbolized with T1, T2, and T3. When we want to run a motor we tide L1 with T1, L2 with T2 and L3 with T3 and if we want to change the direction, we leave L1 with T1 but switch L2 to T3 and L3 to T2.

Following this principle we developed a complete new device which is mounting between initial power leads and electrical motor connections.

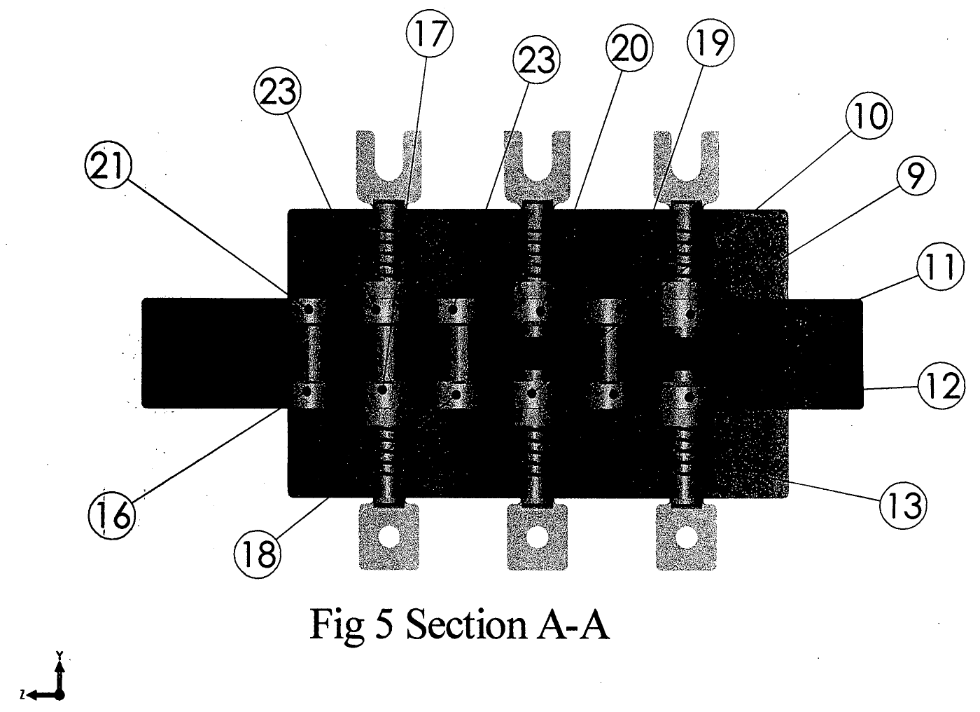

The apparatus (FIG. 3) has two components: Exterior case (1) and Sliding bar (2).On the Exterior case (1) are fit up the Input and Output connections (FIG. 2). On top are Input Connection from L1 (3), Input Connection from L2 (4) and Input Connection from L3 (5). On bottom are Output Connection to T3 (6), Output Connection to T2 (7) and Output Connection to T1 (8). All this connections (FIG. 5) can move up and down and they are pushing by six springs (13) in the Sliding bar (2). The function of springs (13) is to make and keep a perfect contact between connections and index the Sliding bar (2) in one of two positions.

In the Sliding bar (2) are fit up with two groups of connections.

First group (FIG. 5) contain three connections:
A) Input Contact #1 (21) with Output Contact #1(18)
B) Input Contact #3 (23) with Output Contact #3 (16)
C) Input Contact #5 (19) with Output Contact #5 (11)

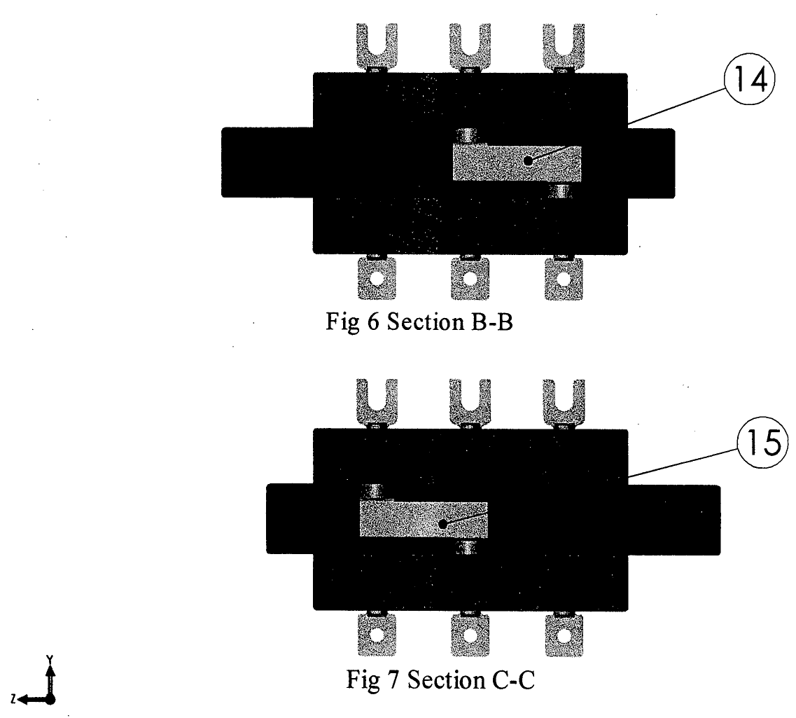

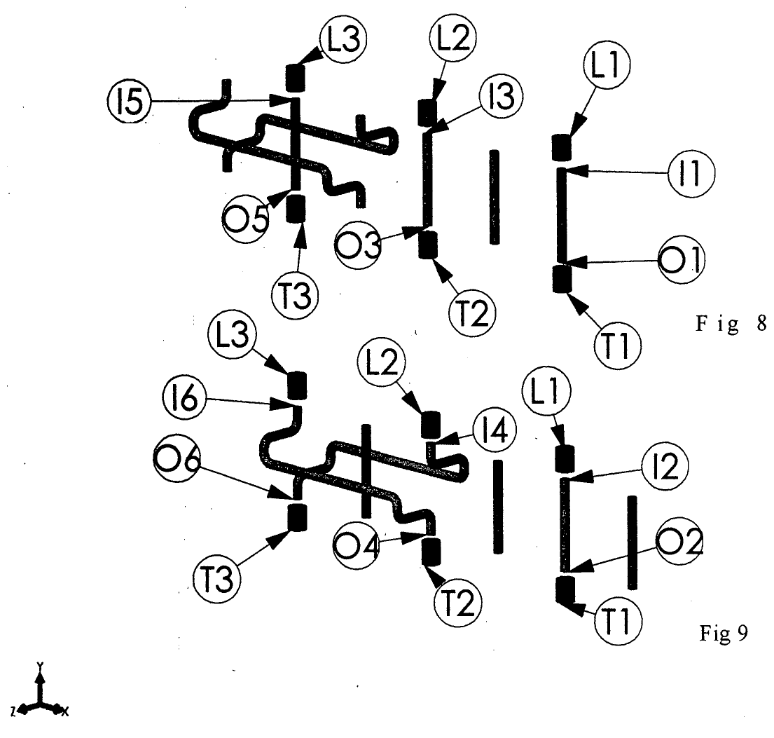

Second group contain three connections too:
D) Input Contact #2 (22) with Output Contact #2 (17)
E) Input Contact #4 (20) with Output Contact #4 (10) using a Particular Link (14) (FIG. 6).
F) Input Contact #6 (9) with Output Contact #6 (12) using a Particular Link (15) (FIG. 7).

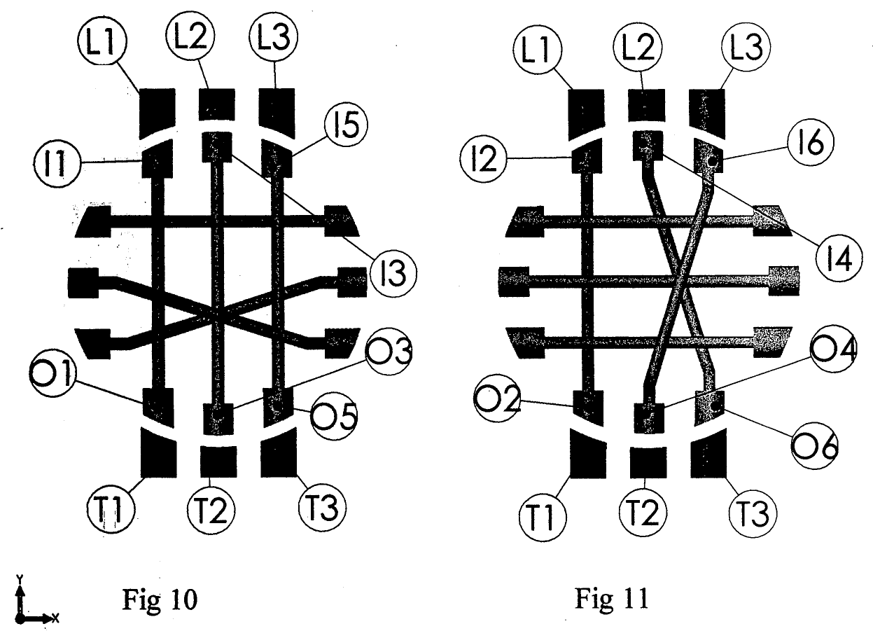

The first connections group is illustrate in Electrical Schema (FIG. 8) and show us one of two ways to tie a motor to the electrical power. The second connections group is illustrate in Electrical Schema (FIG. 9) and we can see the other way to tide a motor to the electrical power.

To change a group to the other is necessary to push by hand the Sliding bar (2) in the Exterior case (1) until is indexing to the new position.

It will also be understood that, in addition to Electrical Phase Reversing Switch, the device can be used to switch the Input power for DC Electrical Motors.

It will also be understood that, in addition to The Linear Motion of the Sliding bar, the device can be used with a Rotating Motion of a Twisting bar.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

### Parts List

1. Exterior Case
2. Sliding Bar
3. Input connection from L1
4. Input connection from L2
5. Input connection from L3
6. Output connection to T3
7. Output connection to T2
8. Output connection to T1
9. Input contact #6
10. Output contact #4
11. Output contact #5
12. Output contact #6
13. Flexible element used to keep the connections in contact
14. Connection from Input contact #4 to Output contact #6
15. Connection from Input contact #6 to Output contact #4
16. Output contact #3
17. Output contact #2
18. Output contact #1
19. Input contact #5
20. Input contact #4
21. Input contact #1
22. Input contact #2
23. Input contact #3

1. What we claim as our invention is a device that will have the ability to switch electrical power in a motor allowing it to move from forward to reverse rotation, with the crossing of two of three electrical leads with two of three contact points.

2. What we claim as our invention is the linear or rotation movement of the contact bar between the leads and connections.

3. What we claim as our invention has the ability to attach this device directly to an already in place motor starter overload block.

4. What we claim as our invention is the use of only one Electrical Motor Starter connected with this device to reverse the motion.

5. What we claim as our invention is the crossing contacts connections in different plans of the same Contact bar view to realize the switching Leads wire to the Motor connection.
